(19) United States
(12) Patent Application Publication
(10) Pub. No.: US 2004/0160947 A1
(43) Pub. Date: Aug. 19, 2004

(54) Voip systems

(76) Inventors: William Geoffrey Hardy, Coventry (GB); Vittoriano Grandi, Genova (IT)

Correspondence Address: KIRSCHSTEIN, OTTINGER, ISRAEL, & SCHIFFMILLER, P.C., 489 FIFTH AVENUE, NEW YORK, NY, 10017

(21) Appl. No.: 10/472,669

(22) PCT Filed: Mar. 11, 2002
(86) PCT No.: PCT/GB02/01085

(30) Foreign Application Priority Data
Mar. 20, 2001 (GB) 0106918.6

(51) Int. Cl. H04M 1/64; H04L 12/66

(52) U.S. Cl. 370/352; 379/88.17

(57) ABSTRACT

A call agent, which acts as a proxy terminal is included in a network termination between a user network an access network. The proxy terminal communicates with a gatekeeper VoIP server in a managed IP network. The proxy terminal is first registered with the VoIP server to which it appears as a terminal device. The individual terminal devices are then registered with the call agent. This may include POTS phones if a gateway is included between the POTS phone and the call agent. This arrangement means that all devices in a users home can have a single public IP address and that each can answer VoIP calls and each device can make VoIP calls. The proxy terminal also provides bandwidth management, rejecting or renegotiating calls if there is insufficient bandwidth to handle them.

This invention relates to Voice over Internet Protocol (VoIP), that is the transmission of voice based conversations over the Internet. The term VoIP can include pure voice communication or voice communication with other elements such as video.

Internet based telephony is well known and subscribers can make voice or video calls across the Internet either from a bespoke VoIP phone or from a computer such as a PC running a VoIP application.

VoIP is an attractive method of communicating between parties. However, existing systems suffer from a number of disadvantages. One of the most significant is the inflexibility of existing systems which demand that a call to a given IP address is answered only at the device having that address. Thus in a domestic environment in which a user has two IP phones and a PC based VoIP application, each of the three devices will have a separate IP address. The devices can therefore only be called separately. This is potentially extremely annoying to a user who has to determine which phone is ringing before he can answer a call. The phones may be in a different part of the house which adds to the annoyance.

Existing VoIP phones also suffer from the disadvantage of not being integrated with existing PSTN based telephone handsets (referred to as POTS—Plain Old Telephony System) These may be referred to as conventional telephones, a term that includes phones such as ISDN phones. Thus, a call to a POTS phone cannot be answered by an IP phone and vice versa. This merely adds to the difficulties experienced by a user in trying to work out which phone to answer.

The invention aims to overcome the disadvantages mentioned above. Broadly the invention contemplates the use of a proxy terminal between a VoIP server and a number of communications devices. The proxy terminal appears to the server as a single terminal and effectively implements a unique virtual telephone. All the devices attached to the proxy terminal can then share an IP address.

More specifically, there is provided A VoIP communications system comprising: a plurality of communications devices at a first user; a proxy terminal connected to the plurality of first user communications devices; a server at a remote network, connected to the proxy terminal; and a plurality of further user devices attached to a network for communication with the first user devices across a communications channel established by the server and the proxy terminal.

The invention also provides a method of communicating between a first communications device and a second communications devices across a VoIP network, the first communications device being attached to a proxy terminal, comprising: registering the proxy terminal with a service provider server; registering the first communications device with the proxy terminal; sending a call request from the first communications device to the proxy terminal; forwarding the call request from the proxy terminal to the service provider server; notifying the proxy terminal by the server of the address of the second device; notifying the first communications device of the address to which to send media; sending a call set up message to the second communications device via the proxy terminal and the server, and on the second communications device answering the call set up message, establishing a communications channel between the first communications device and the second communications device either directly or via the proxy terminal.

Embodiments of the invention have the advantage that all devices connected to a proxy device share a public IP address. This means that calls made to that address can be presented to all of the terminals. Thus, all the phone connected to the proxy terminal will ring when there is a call to the IP address.

Preferably, a gateway is connected to the proxy terminal so that POTS phones can also be connected. The gateway translates between analog POTS signals and data packets used in VoIP networks.

Preferably a gateway is included at the remote network including the server to a PSTN. This has the advantage of enabling calls from standard phones using standard telephone numbers to be received either at standard phones or IP phones/computer based IP applications.

Embodiments of the invention will now be described, by way of example, and with reference to the accompanying drawings, in which:

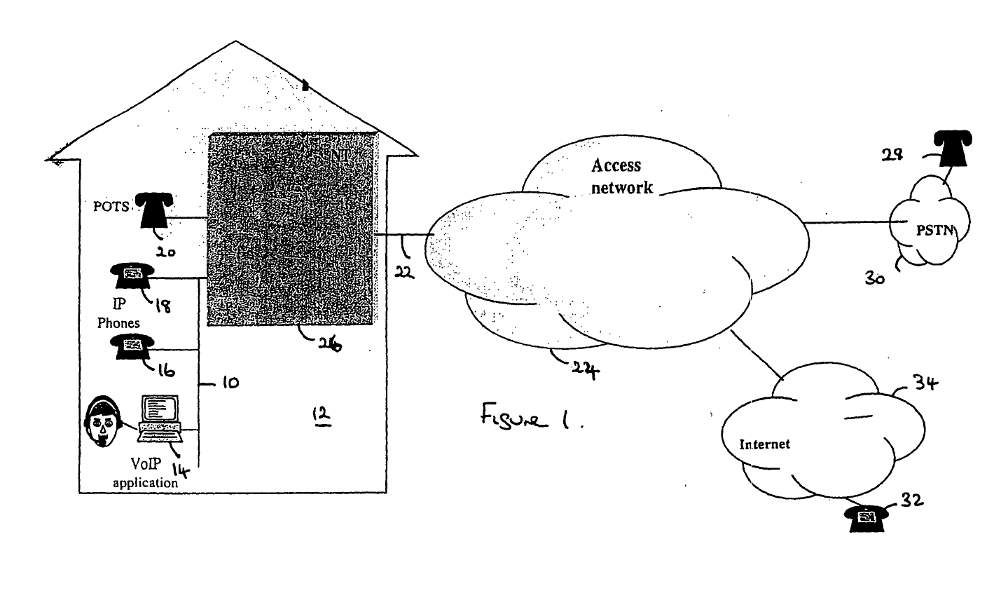

FIG. 1 is a schematic diagram showing the capabilities of a system embodying the invention;

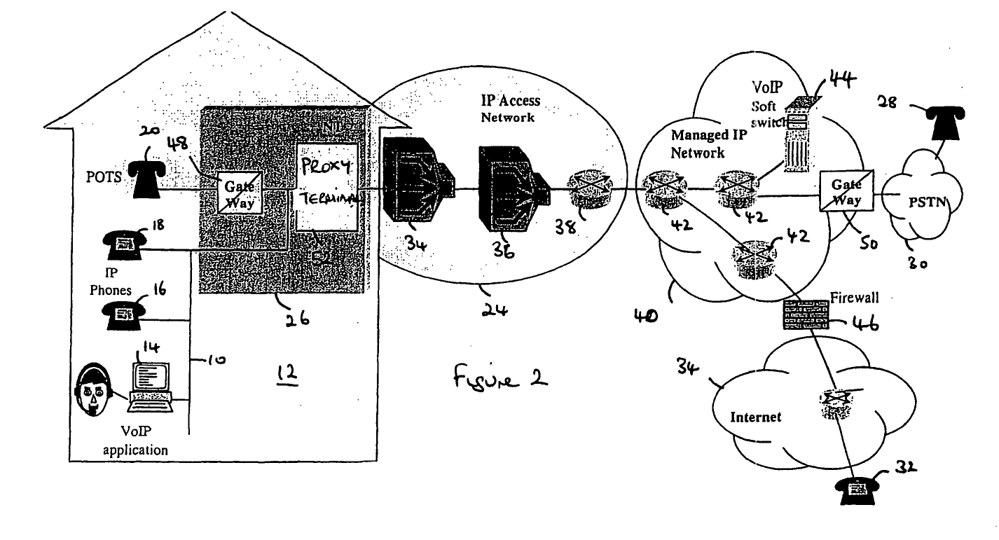

FIG. 2 is a schematic diagram illustrating an embodiments of the invention;

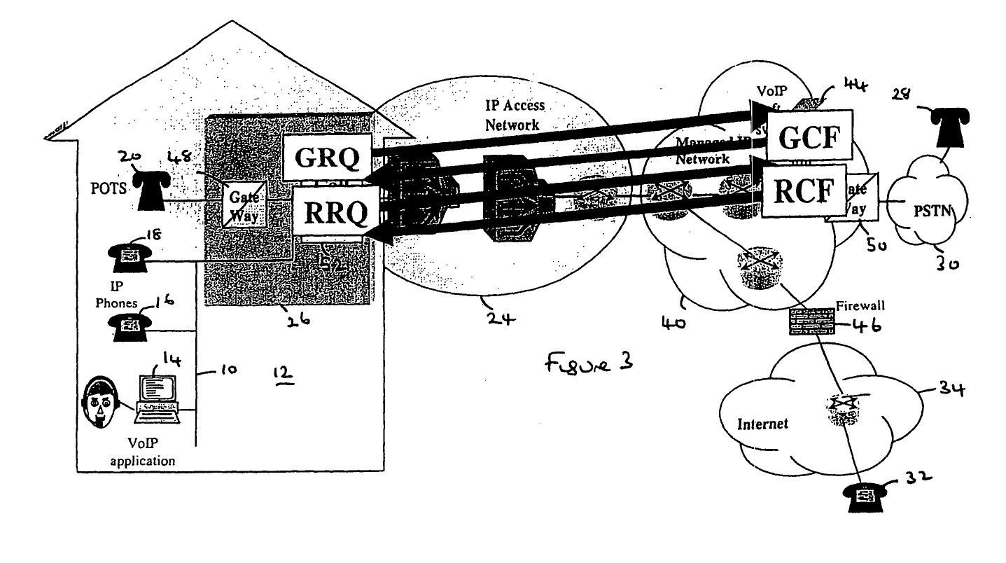

FIG. 3 is a similar view to FIG. 2, showing how the proxy terminal of FIG. 2 registers with the system provider;

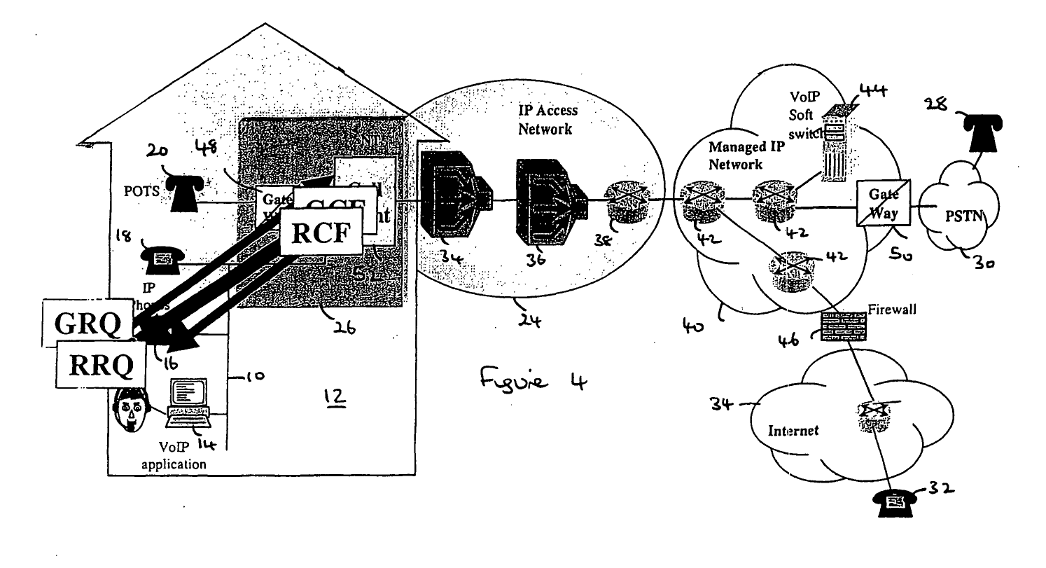

FIG. 4 is a similar view to FIGS. 2 and 3, showing how individual terminals register;

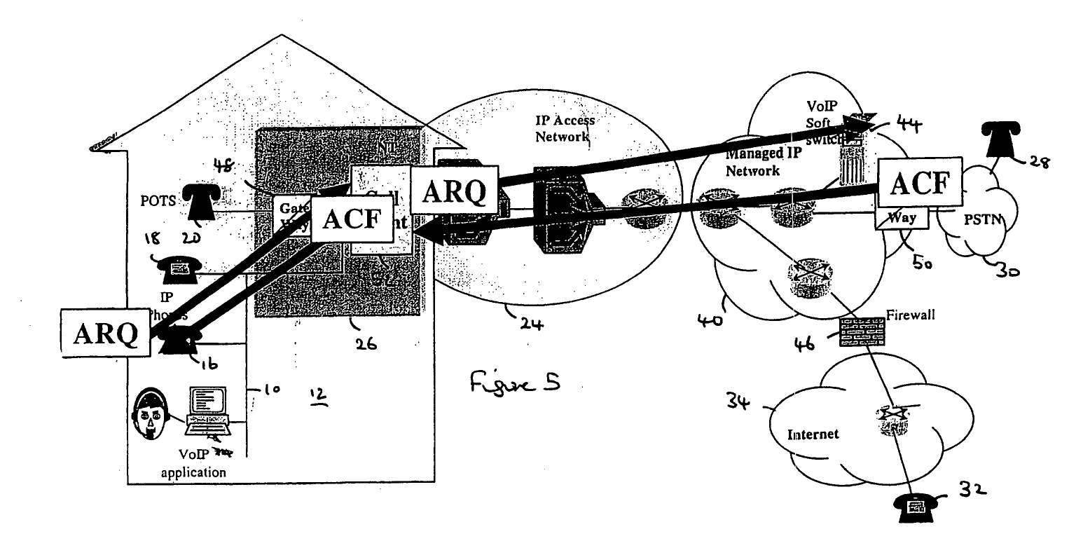

FIG. 5 is a similar view to FIGS. 2 to 4 showing the message path when a terminal seeks permission to make a call;

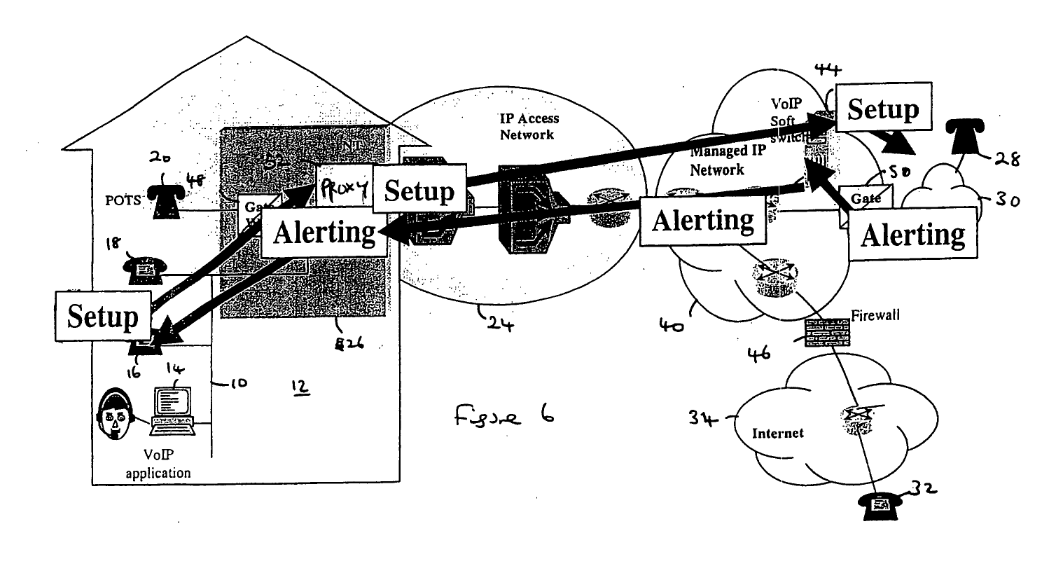

FIG. 6 is a similar view to FIGS. 2 to 5, showing the message flow during the set up of a call; and

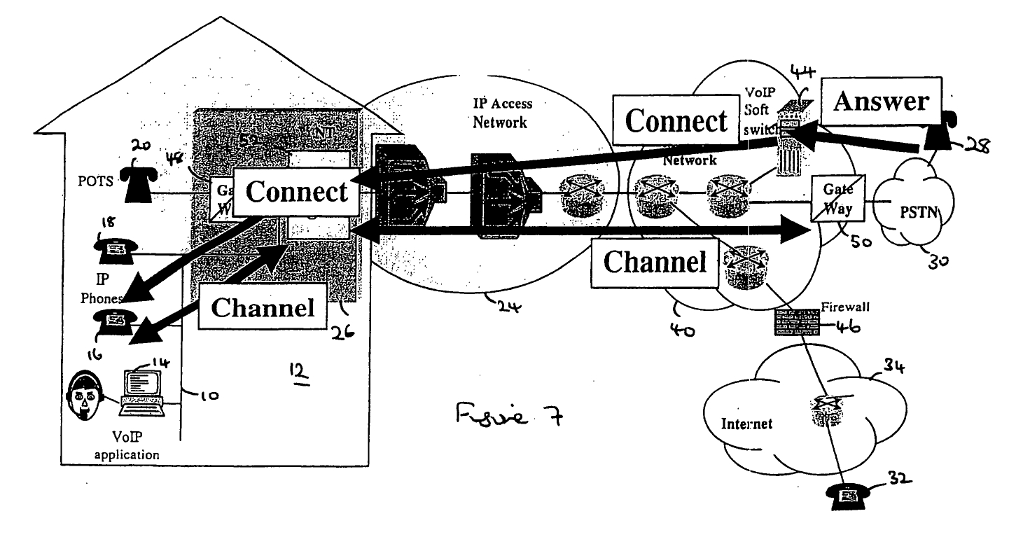

FIG. 7 is a similar view to FIGS. 2 to 6 showing call connection.

FIG. 1 shows an internal network 10 within a domestic establishment 12. The network includes a PC 14 running a VoIP application and two IP phones 16, 18. The house also has a conventional POTS telephone 20. The POTS phone and the network share a single external line 22 which connects to the an Access network 24 via a network terminator 26. The network terminator is the last stage of the network owned by the service provider. The illustration given in FIG. 1 applies equally to a business environment.

The POTS phone has a telephone number, say 024 76123456. It is desirable for calls to be made to the POTS phone or the IP phones both from the Internet and the PTSN (Public Switched Telephone Network). It is also desirable to be able to make calls from either the IP phones or the POTS phone to both POTS phones and the Internet. This is illustrated in FIG. 1 by POTS phone 28 attached to the PSTN 30 and IP phone 32 attached to the Internet. The Access network is connected to both the PSTN and the Internet.

It is also desirable to be able to answer calls made to the POTS phone number 024 76123456 at any of the POTS phones and the IP phones (including the PC based IP application). Thus it is desirable that all the phones ring when a call is made either to the POTS phone or one of the IP phones or the VoIP application. Moreover it desirable that this functionality is provided with only a single line, that is the user has subscribed only to a single line and can only make one call at a time. Of course, a subscriber may choose to subscribe to several lines if he wants to be able to make simultaneous calls.

FIG. 2 illustrates how these desiderata may be achieved. The IP access network 24 is shown as including a pair of concentrators 34, 36 and a router 38. The structure of this network is well known. Interposed between the IP access network and the PSTN 30 and Internet 34 is a managed IP network 40 which includes a plurality of routers 42 and a VoIP Softswitch 44 or gateway 50. The Softswitch 44 is conveniently a telephony server. A firewall 46 is arranged between the Managed IP network 40 and the Internet.

The POTS phone 20 at the user is connected to the network termination (NT) 26. The NT 26 includes a gateway 48 and a further gateway 50 is included in the Managed IP network 40 between that network and the PSTN 30. The purpose of the gateways is to convert analog signals from the POTS phones into digital data packets; that is to convert the signal format into that used by the IP phones and IP phone application.

The NT also includes a proxy terminal 52. The purpose of the proxy terminal is to appear to the VoIP Softswitch 44 to be a terminal device. All the devices connected to the proxy terminal will have an internal address. The proxy terminal provides network address translation between these private addresses and the access network. The use of a proxy terminal has a number of advantages as will become clear from the following discussion.

VoIP calls are governed by a number of standards, including ITU-T standard H.323. FIGS. 3 to 7 show how the various requirements of this standard can be implemented using the proxy terminal of FIG. 2.

The VoIP server 44 and the managed IP network 40 are provided by a VoIP service provider. It is necessary for subscribers first to register with the service, in fact with the server 44 before calls can be made. In the prior art, this has been done by individual phones or applications registering with the server. In the embodiment of the present invention, the proxy terminal registers on behalf of all the devices owned by a given user FIG. 3), and then those devices register with the proxy terminal (FIG. 4).

Thus in FIG. 3, the proxy terminal sends a gatekeeper discovery message GRQ through the system. The term gatekeeper is synonymous with VoIP softswitch and the purpose of this message is to locate the VoIP server 44. The message sent is a broadcast message ‘where is my gatekeeper’. The server 44 will acknowledge this message by sending a Gatekeeper confirm message GCF which identifies itself and gives its address ‘I am your gatekeeper, this is my address’. The proxy terminal then sends a registration request RRQ to the server 44 appearing to the server 44 to be a terminal rather than a call agent. The message sent is ‘I am a terminal, this is my signalling address’. The server 44 confirms receipt of this message with a registration confirm message RRQ ‘OK, this is my gatekeeper signalling address’.

It will be appreciated that the server now thinks that the proxy terminal is a single terminal. Thus calls to that terminal address can be sent to all devices connected to the call agent. Those devices must first register with the call agent. This is shown in FIG. 4. The terminal sends a similar set of messages to the proxy terminal as the proxy terminal did to the server 44 in the proxy terminal registration process. Thus, the terminal sends a GRQ Gatekeeper discovery message to the proxy terminal asking ‘where is my gatekeeper’. This is sent as a broadcast message. The proxy terminal replies with a GCF gatekeeper confirm message, signalling ‘I am your gatekeeper, this is my registration address’. The terminal then sends the terminal registration request message RRQ ‘I am a terminal, this is my signalling address’. In response the proxy terminal sends the RCF registration confirm message ‘OK, this is my gatekeeper signalling address.

Each of the terminals perform the same registration process. As each is registered, calls may be made from that terminal. Before a call can be made, the terminal must make, and have granted, an admission request. This process is illustrated in FIG. 5. The admission request ARQ is a request to make a call and is sent from the terminal to the call agent. The proxy terminal forwards the request to the VoIP server 44. The ARQ will include an identification of the destination that the user wants to call, for example its phone number. The server returns an ACF Admission confirm which says to the proxy terminal ‘OK, this is the address of the destination’. The address returned is an IP address and the server converts between phone numbers and IP addresses. The proxy terminal then sends an ACF message to the IP phone or other device, telling the phone its own address, and to use gatekeeper signalling. This is a signalling path that includes the server 44. This is now possible as the terminal has the address of the server.

Once authorisation to make a call has been acquired, the call must be set up. This is illustrated in FIG. 6. The phone sends a set up message to the call agent. The proxy terminal forwards this message on to the server 44 which in turn forwards the message on to the destination, for example a PSTN phone. The phone will ring at the destination and an alert message is sent from the destination to the server, and then back to the terminal via the proxy terminal, to inform the terminal that the phone is ringing at the other end. This alert message is part of the H.323 message sequence and may be a conventional ringing tone or in some other form. Finally, when the remote phone is answered, the call can be connected. This is illustrated in FIG. 7. The answer is communicated to the server 44 and a connect message sent from the server 44 to the proxy terminal 52. The proxy terminal forwards this connect message to the IP phone. Channels for the call are then set up. The channels are set up for media using Terminal capability set exchange and an Open Logical Channel. The are two channels set up: between the terminal and the proxy terminal and between the proxy terminal and the Managed IP gateway 50. It will be appreciated from FIG. 7 that the server 44 is not included in the media channel.

From the foregoing it can be seen that the use of a proxy terminal has a number of advantages. Incoming calls can be answered from any device connected to the call agent, provided it has the capabilities for that call type. This includes POTS phones as well as devices attached to the user's network such as IP phones and VoIP applications. The proxy terminal can offer the call to all devices that have the ability to take that type of call. Thus for example, if the incoming call is a video call, the call will be offered only to any device that can handle video calls.

Outgoing calls can be made from any device that has the capability, again including conventional non VoIP phones. The proxy terminal forwards all calls into the network.

The bandwidth available to user will depend on the terms of the subscription with the service provider. The proxy terminal 52 polices the bandwidth occupied by all calls and can reject any call, incoming or outgoing, which does not meet the available bandwidth. Alternatively it can negotiate for lower bandwidth. The proxy terminal can also share the allocated bandwidth between analog and VoIP phones as necessary.

The proxy terminal can also provide unified QoS (quality of service management). QoS is very important with VoIP as it is essential that the data packets are forwarded through the network with a guaranteed quality of service otherwise a realtime conversation will not be possible. The QoS path has to be maintained both between the proxy terminal and the gateway 50 to the PSTN and between the proxy terminal and the firewall.

It will be appreciated that the user only requires a single public IP address for all the terminals connected to the call agent. However, to increase capacity, a proxy terminal can be registered twice, or more often, with the server 44. This is equivalent to having two or more phone lines. Each registration has a separate IP address and a ‘separate’ phone number. Each of the devices connected to the proxy terminal has a separate internal, private address. Thus the number of devices that can be connected has no real limits, beyond the capacity of the domestic LAN.

It will be appreciated that the embodiment described has been simplified for ease of explanation. A single user has been mentioned, although, in practice many users will be connected, each having a call agent. The location of the proxy terminal is not important. It has been described as being part of the network termination. In some countries, discrete network terminations are not used. It will be appreciated that the proxy terminal must simply be positioned between the user and the IP access network such that all the user's devices can be connected to the call agent.

The preceding description has been given in relation to an access network. However, the invention is applicable to any telecommunications network or business LAN in which a proxy terminal function is incorporated into a network element.

Various other modifications are possible and will occur to those skilled in the art without departing from the scope of the invention which is defined by the following claims.

1. A VoIP communications system comprising:
a plurality of communications devices at a first user;
a proxy terminal connected to the plurality of first user communications devices;
a server at a remote network, connected to the proxy terminal; and
a plurality of further user devices attached to a network for communication with the first user devices across a communications channel established by the server and the proxy terminal.

2. A VoIP communications system according to claim 1, wherein the proxy terminal is configured to appear to the server as a communications terminal.

3. A VoIP communications system according to claim 1 or 2, wherein the first user devices attached to the proxy terminal have a common public IP address.

4. A VoIP communications system according to any of claims 1 to 3, wherein the communications devices attached to the proxy terminal include IP phones and/or IP phone applications.

5. A VoIP communications system according to any preceding claim, wherein the devices attached to the proxy terminal includes a conventional telephone.

6. A VoIP communications system according to claim 5, comprising a gateway between the conventional telephone and the proxy terminal for converting data from the conventional telephone into a format suitable for transmission over an IP network.

7. A VoIP communications system according to any preceding claim, wherein the further user devices include conventional telephone terminals connected to the remote network by a PSTN, comprising a gateway arranged between the remote network and the PSTN for converting data from the IP network into a format suitable for transmission over a conventional telephone.

8. A VoIP communications system according to any preceding claim, wherein the proxy terminal provides a QoS path between the first user terminals and the proxy terminal, and between the proxy terminal and the server.

9. A VoIP communications system according to any preceding claim, comprising an access network between the user devices and the remote network, wherein the proxy terminal is part of the access network.

10. A VoIP communications system according to claim 9, wherein the proxy terminal is part of a network termination to the first user.

11. A VoIP communications system according to any preceding claim, wherein the proxy terminal includes an address translator for translating between internal network addresses of the user communications devices and a public IP address common to all the first user devices.

12. A VoIP communications system according to any preceding claim, wherein the proxy terminal comprises a call admission control function for monitoring available bandwidth and rejecting incoming or outgoing calls if insufficient bandwidth is available.

13. A VoIP communications system according to any preceding claim, comprising a plurality of proxy terminals each having a plurality of user devices attached thereto.

14. A method of communicating between a first communications device and a second communications devices across a VoIP network, the first communications device being attached to a proxy terminal, comprising:
registering the proxy terminal with a service provider server;
registering the first communications device with the proxy terminal;
sending a call request from the first communications device to the proxy terminal;
forwarding the call request from the proxy terminal to the service provider server;
notifying the proxy terminal by the server of the address of the second device;
notifying the first communications device of the address to which to send media;
sending a call set up message to the second communications device via the proxy terminal and the server, and
on the second communications device answering the call set up message, establishing a communications channel between the first communications device and the proxy terminal and the proxy terminal and the second communications device.

15. A method according to claim 14, wherein the step of registering the proxy terminal with a service provider server comprises broadcasting a gatekeeper discovery message from the proxy terminal.

16. A method according to claim 14 or 15, wherein the step of registering the first communications device with the proxy terminal comprises broadcasting a gatekeeper discovery message from the first communications device.
